(19) United States
(12) Patent Application Publication
(10) Pub. No.: US 2024/0144082 A1
(43) Pub. Date: May 2, 2024

(54) Data Set Distance Model Validation

(71) Applicant: Microsoft Technology Licensing, LLC, Redmond, WA (US)

(72) Inventors: Ivan TARAPOV, Redmond, WA (US); Jameson MERKOW, San Diego, CA (US); Stephen KAISER, Seattle, WA (US); Smitha Srinivasa SALIGRAMA, Bellevue, WA (US); Steven Joel BORG, Seattle, WA (US); Matthew P. LUNGREN, Palo Alto, CA (US); Arjun SOIN, Los Altos, CA (US)

(21) Appl. No.: 18/051,786

(22) Filed: Nov. 1, 2022

(51) Int. Cl. G06N 20/00

(52) U.S. Cl. CPC G06N 20/00

(57) ABSTRACT

A method of validating an inferential model for operation on an inference data set is provided. The method includes extracting a first distribution of values of a first parameter from the inference data set, extracting a second distribution of values of the first parameter from a validating data set used to validate the inferential model, determining a first parameter distance between the extracted first distribution and the extracted second distribution, and validating the inferential model for operation on the inference data set based on satisfaction of a validation condition, the satisfaction of the validation condition being based on the determined first parameter distance.

### BACKGROUND

After training, inferential models, such as machine learning models, are validated by confirming that the output of the inferential models is valid for a given type of input data. Such types may include, without limitation, data having a similar demographic distribution or other similar shared characteristics. With supervised learning validation techniques, the results may be initially validated on input data of a given type by comparing the output values from the model with labeled or known values. Validating the inferential models provides objective evidence that the output of the inferential models is reliable.

### SUMMARY

The described technology validates an inferential model for operation on an inference data set. A first distribution of values of a first parameter from the inference data set is extracted. A second distribution of values of the first parameter from a validating data set used to validate the inferential model is extracted. A first parameter distance between the extracted first distribution and the extracted second distribution of the values of the first parameter from the validating data set is determined. The inferential model is validated for operation on the inference data set based on satisfaction of a validation condition. The satisfaction of the validation condition is based on the determined first parameter distance.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates example systems for validating an inferential model.

FIG. 2 illustrates an example data distance inferential model validation system.

FIG. 3 illustrates an example of data throughput of a data distance inferential model validation system.

FIG. 4 illustrates example operations for validating an inferential model for operation on an inference data set.

FIG. 5 illustrates an example computing device for implementing the features and operations of the described technology.

### DETAILED DESCRIPTIONS

Inferential models, such as machine learning models, are trained to receive input data and responsively yield output data. Supervised training methods rely on labeled data, which includes input data and corresponding expected output data that is expected to be output from the inferential model in response to the introduction of the input data to the inferential model. Because conditions can change with time, an inferential model can drift to yield output that is different from the expected output. For example, if the inferential model is deployed for an inference data set collected under conditions different from the conditions under which the validating data used to validate the inferential model was collected, the inferential model may be invalid for the inference data set.

One source of drift is a covariate shift (also called input or feature drift). Covariate shift is a deviation within input variables of time-series data. Covariate shift is common in medical imaging examples include changes to imaging protocols, imaging software or equipment updates, and changing patient demographics. After a covariate shift, a deployed model may be operating in an untested or poorly validated environment wherein performance degradation becomes an obvious concern. When a significant time gap exists between contemporary data and model deployment, the likelihood of drift and, consequently, classification errors, increases. For healthcare AI systems, drift-associated errors can cause unwarranted harm to patients.

Another source of drift is concept drift. Concept drift occurs when the relationship between data input into an inferential model and data responsively output by the inferential model changes. Many inferential models (e.g., artificial intelligence systems) are built upon stationarity. Stationarity is the idea that the characteristics of a target class remain static. This assumption allows inferential models to be trained to identify the characteristics and then predict the presence of the target class in unseen data. This assumption is not always valid, particularly when the target class can be influenced by outside factors. For example, the impact of a novel respiratory illness pandemic on an automated chest X-ray interpretation model trained prior to the spread of the novel respiratory illness. A model designed to predict mortality for patients who have contracted the novel respiratory illness using chest radiograph images may work on a dataset taken from the height of the pandemic, but as treatments advance and disease prevalence shifts, the mortality outcome based on imaging features may no longer be sufficient for accurate prediction. Isolating the effects of covariate shift to determine drift can provide improved inferential model systems.

At inference time, a user typically does not have access to labeled output data (e.g., ground truth data) to determine whether output data yielded by the inferential model is valid. Accordingly, the user may not be able to determine whether the inferential model is valid for operation on inference input data of the inference data set.

In real-world situations where labeled data is unavailable, alternative model validation strategies can be deployed. For example, using the described technology, rather than validating by comparing outputs from the inferential model with labeled outputs, a system can compare an inference data set with a validating data set for which the inferential model has been previously validated to validate the inferential model for operation on inference input data of the inference data set. The validating data set and the inference data set include values of parameters shared between the validating data set and the inference data set. The shared parameters include model input data (e.g., sensor data) to be input into the inferential model, metadata (e.g., metadata associated with the input data of conditions under which model input data is collected), or model output data output from the inferential model in response to input of the input data.

In implementations, the comparison of the inference data set with the validating data set includes comparing the shared parameters individually. For each shared parameter, a distribution of values of the shared parameter from the inference data set and a distribution of values of the shared parameter from the validating data set is determined. The comparison includes determining a parameter distance between the distribution of values of the shared parameter from the inference data set and the distribution of values of the shared parameter from the validating data set. Parameter distances can be determined for one or more of the shared parameters. Implementations are also contemplated in which the values are compared in addition to or instead of the parameter value distributions.

In implementations, when the comparison includes more than one parameter, the determined parameter distances can be aggregated to form a single aggregate distance. In an implementation, the aggregation of the parameter distances includes preprocessing each of the parameter distance values. The preprocessing includes normalization and/or weighting of the parameter distances. Normalizing includes scaling the parameter distances to a predetermined range of values. Normalizing ensures that the scale of the parameter distances is consistent between samples and between different parameters. Weighting includes applying relative correlative weights to (e.g., multiplying the corresponding weights by) each of the parameters. The relative correlative weights are based on the relative relevance or value of the parameters to the overall validity of the inferential model. Weighting the parameter distances emphasizes parameters that have a larger impact on inferential model validity over parameters that have less impact on model validity. In an implementation, the preprocessed parameter distances are then combined (e.g., by summing the preprocessed parameter distances) to generate an aggregate distance. Determining an aggregate distance can simplify the comparison with reference distance data and interpretation of the validity of the inferential model. In alternative implementations, each of the parameter distances (preprocessed or otherwise) can be separately considered for validating the inferential model for operation on the inference data.

The inferential model is validated based on a determination that a validation condition is satisfied. The validation condition includes a comparison of the determined parameter distance data with reference distance data. For example, if the difference between the determined parameter distance data and the reference distance data exceeds a predefined threshold or falls outside of a predefined range, the inferential model may be invalidated for operation on the inference data set.

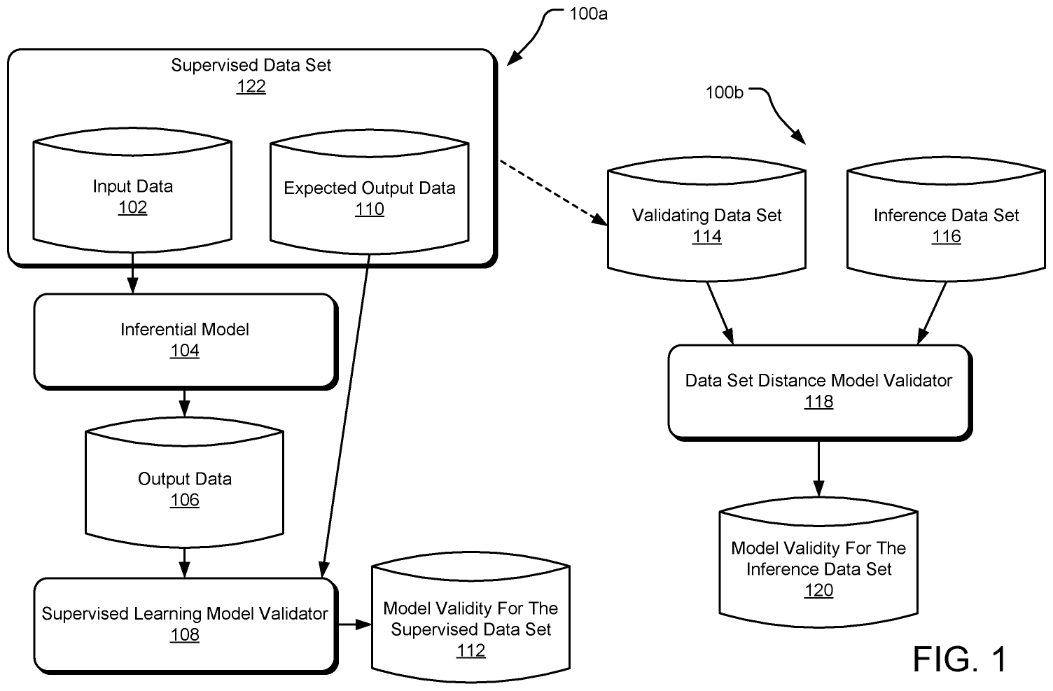

FIG. 1 illustrates example systems 100a and 100b for validating an inferential model 104. A supervised learning model validation system 100a requires that input data 102 input into the inferential model 104 be “labeled” with expected output data 110. The input data 102 and/or the output data are included in a supervised learning data set 122. In the supervised learning data set 122, each sample of the input data 102 corresponds with an expected output label of the expected output data 110. The expected output data 110 is the data that is expected to be output by the inferential model 104 in response to the input of the input data 102 into the inferential model 104.

The inferential model 104 provides output data 106 in response to the input of the input data into the inferential model 104. The output data 106 may differ from the expected output data 110. A supervised learning model validator 108 compares the output data 106 with the expected output data 110 to determine the validity of the inferential model for operation on the input data 102. For example, the supervised learning model validator 108 may determine an error or loss between the output data 106 and the expected output data 110. The error can be determined over each sample or over a number of samples. The model validity for the input data 112 represents whether the inferential model 104 is valid for operation on the input data 102. The supervised learning model validator 108 requires the expected output data 110 to validate the inferential model 104. Labeling the input data 102 involves generating the expected output data 110 corresponding to the input data 102. The labeling can require human intervention or extra automation steps that are implausible to conduct in real-time at inference time when deploying the inferential model 104 in a real-world scenario. Output data output from the inferential model 104 collected at inference time can drift depending on whether changing circumstances are well-reflected in the input data 102. The drift may be sufficient such that the inferential model 104 is no longer valid for operation on new inference-time input data. Accordingly, the supervised learning model validation system 100a is incapable of determining whether the drift has invalidated the inferential model 104 for operation on new input data.

A data set distance model validation system 100b validates the inferential model 104 without the expected output data 110 for the new input data. The data set distance model validation system 100b compares a validating data set 114 on which the operation of the inferential model has already been validated with an inference data set 116 on which the operation of the inferential model has not been validated. For example, the validating data set 114 is collected in a controlled setting or is otherwise validated before the inference data set 116 is collected. The inference data set 116 is collected in a setting where the output of the inferential model 104 in response to input of inference input data from the inference data set 116 cannot readily be verified (e.g., the inference data set 116 is unlabeled). In implementations, the validating data set 114 was used in to train the inferential model 104 (e.g., alternatively or in addition to being used to validate the inferential model 104). A data set distance model validator 118 compares the validating data set 114 with the inference data set 116 to determine model validity for the inference data set 120. Because the validating data set 114 and the inference data set 116 can be made available in real-time in a real-world setting, the data set distance model validator 118 can validate the inferential model 104 for operation on the inference data set 116 without verifying the correctness of the inference output data from the inference data set 116.

In an implementation, the data set distance model validator 118 determines a distance or difference (e.g., similarity or dissimilarity) between the validating data set 114 and the inference data set 116. The inferential model 104 has been validated for operation on the validating data set 114. The validation was conducted by supervised learning validation, as illustrated by the supervised learning model validation system 100a or by a previous iteration of data set distance validation illustrated by the data set distance model validation system 100b (e.g., in a validation chain that was originally validated based on a supervised learning validation).

The validating data set 114 includes validating input data for input into the inferential model 104 and/or includes validating output data, including validating output parameter values, output from the inferential model 104 responsive to the input of the validating input data into the inferential model 104. The inference data set 116 includes inference input data for input into the inferential model 104 and/or includes inference output data output from the inferential model 104 responsive to the input of the inference input data into the inferential model 104. In an implementation, the inferential model 104 was validated on the supervised learning data set 122 using the supervised learning model validation system 100a, and the validating data set 114 includes at least a portion of the supervised learning data set 122 (as illustrated in FIG. 1 by a dashed arrow).

In an implementation, the validating input data and inference input data include sensor data and/or metadata. The sensor data is time series or discrete data detected by a sensor. The sensor data can include one-dimensional (e.g., a simple data point for each time or discrete sampling point), two-dimensional (e.g., an image), or three-dimensional (e.g., a depth image or a three-dimensional composite of two-dimensional images). Examples of one-dimensional sensor data include measurements of temperature, blood analyte levels, other chemical level detections, physical displacements (e.g., of a person, animal, or object), and the like. The data set distance model validator 118 can use the sensor data to validate the inferential model 104 for operation on the inference data set 116.

In implementations, the sensor data can include image data, such as static image data (e.g., an x-ray of a patient) or dynamic imaging data (video data). In implementations, rather than accepting raw image data, the inferential model 104 is configured to operate on reduced representation image data. Reduced representation image data can be generated by vectorizing and/or encoding the image data. For example, prior to introduction to or as an element of the inferential model 104, images are reduced using vectorizing or encoding methods (e.g., by variational autoencoding, other autoencoding, downsampling, or other vectorizing or compression methods).

The metadata is data that describes data to be input into the inferential model 104. In an implementation, the inferential model 104 is configured to receive some or all of the metadata as input for inferential determinations. In an implementation, the metadata described sensor data to be input into the inferential model 104 and can be used by the data set distance model validator 118 to validate the inferential model 104 (e.g., even if the inferential model 104 is not configured to receive the metadata as input).

The data set distance model validator 118 validates the inferential model 104 for operation on the inference data set 116 using data set distance validation. Data set distance validation includes comparing the validating data set 114 and the inference data set 116 to determine a distance between the validating data set 114 and the inference data set 116. In an implementation, a parameter distance is determined for each parameter shared by the validating data set 114 and the inference data set 116. The data set distance model validator 118 is configured to take a portion or all of the shared parameters as input. In implementations, the shared parameters compared are a subset of parameters shared between the validating data set 114 and the inference data set 116.

In an implementation, in order to compare data for a number of samples (e.g., different data captured under different circumstances), rather than comparing single values of the shared parameters, the values of each shared parameter are extracted and assembled into distributions for each of the validating data set 114 and the inference data set 116. Consequently, the data set distance model validator 118 directly compares distributions of values for each shared parameter of the validating data set 114 with values for each shared parameter of the inference data set 116 to determine a parameter distance for each shared parameter. The comparison of distributions of parameter values can help reduce biases associated with the number of samples collected in each of the validating data set 114 and the inference data set 116.

In implementations, the data set distance model validator 118 controls the sampling of the values of the shared parameters used in the distributions of the values of each shared parameter of the validating data set 114 and inference data set 116 to prepare the distributions for comparison. In an implementation, the values of sensor data and/or metadata parameters for the validating data set 114 and the inference data set 116 are sampled using a rolling detection window technique, an over-sampling technique, and/or a detection window set technique.

In an implementation, to construct sample detection windows, the data set distance model validator 118 generates the parameter value distributions using a sliding window technique. Sliding window sampling functions have parameters for window length (l) and stride (s). The window length determines the size of each window, and the stride denotes the spacing between neighboring samples. Temporal-based stride and window length values are used to collect all sensor data (e.g., from patient exams) within a time window, looking back from the indexed date. For example, if the window length is 30 days, then a sample for December 31st would include all exams from December 1st through December 31st. In an implementation, the multiple parameter values, mᵢ from each detection window, ω are calculated using parameter functions Ψᵢ(ω)=mᵢ.

In an implementation, to construct sample detection windows, the data set distance model validator 118 generates the parameter value distributions using an oversampling technique. In implementations, similarity metrics are sensitive to sample size; even when two samples are drawn from the same distribution, the samples may produce differing results simply due to sample size. An oversampling technique mitigates this issue by repeatedly calculating metrics on a fixed-size sample and calculating an average result. In an implementation, a bootstrap method that samples the detection window to draw K samples is used. Metrics are then calculated on this bootstrapped sample. The process is repeated N times, and the results are averaged to obtain a final value. More formally, computation of a given metric on a detection window is a function Θ(·) that uses the sample and another function, θ^{K} to collect K samples from a detection window ω to calculate the metric ψᵢ, which is done N times, and then the results are aggregated as illustrated by equation (1),

$${Θ}_{ψ} ( ω , N , K ) = {\hat{ψ}}_{i} ( ω ) = {\hat{m}}_{i} = \frac{1}{N} {\sum }_{0}^{N} {ψ}_{i} ( {θ}^{K} ( ω ) ) , \qquad ( 1 )$$

where θ^{K} is a function that collects K samples from ω with replacement.

In an implementation, to construct sample detection windows, the data set distance model validator 118 generates the parameter value distributions using a detection window set technique. A detection window set is a collection of detection windows, where each detection window is typically captured with a time index. If the detection window taken at time t is denoted as ω^{t}, then some detection window set taken from time a to time b is defined as Ω^{[a,b]}={ωₐ, ωₐ₊₁, . . . , ω_{b-1}, ω_{b}}. Metrics (parameter values) are then collected at each time step, resulting in a metric (parameter) value set at multiple time steps: \hat{ψ}ᵢ(ω^{t})=\hat{m}ᵢ^{t} is defined as an individual metric (parameter) calculated at time t from detection window ω^{t}. Then metric (parameter) values \hat{m}ᵢ^{[a,b]}={\hat{m}ᵢ^{a}, \hat{m}ᵢ^{a+1}, . . . , \hat{m}ᵢ^{b-1}, \hat{m}ᵢ^{b}} are captured as the collection of \hat{m}ᵢ^{t} from time a to time b. Consequently, \hat{m}ᵢ^{[a,b]} is used as an individual measure of drift over time.

After the data set distance model validator 118 extracts and assembles the distributions of values of the shared parameters, the data set distance model validator 118 compares the extracted distributions of the shared parameters to determine distances between the distributions of values of shared parameters. In an implementation, the data set distance model validator 118 separately compares distributions of values of the validating data set 114 and the inference data set 116 for each shared parameter to determine parameter distances for each shared parameter.

In an implementation, the data set distance model validator 118 uses a Kolmogorov-Smirnoff test (K-S test) to determine distances between distributions of parameter values with continuous values (or values of continuous variables sampled discretely). The K-S test is a non-parametric test used to measure the distribution shift of continuous variables from a reference sample. As a non-parametric test, the K-S test compares samples without assuming a specific distribution of a variable, making the K-S test an efficient and effective way to distinguish the distribution change from one time to another. Other tests for determining a distance between the distributions of continuous parameter values are contemplated.

In an implementation, for categorical features, the data set distance model validator 118 uses a X² (chi-square) goodness of fit test to determine distances between distributions of parameter values. The X² goodness of fit test is used to compare observed frequencies in data and compares them to expected values. The X² goodness of fit test, calculates if an input sample with observed frequencies is likely to be obtained from the frequencies observed in the reference set. Other tests for determining a distance between the distributions of categorical or discrete parameter values are contemplated.

Examples of other methods the data set distance model validator 118 can use to determine distances between distributions of parameter values include a population stability index (PSI), a Kullback-Leibler divergence (KL), A Jensen-Shannon divergence (JS), a Wasserstein distance (WD), a Bhattacharyya distance, a Hellinger distance, a Fisher's Exact Test, and a vector norm. PSI is a drift metric for numerical and categorical features. Instead of a p-value, you get a number that can take any value from 0and above. It also reflects the relative “size” of the drift. The larger the PSI value, the more different the distributions are. KL to PSI in that it begins with defining a number of bins to use KL for numerical features. Due to this, the KL metric value does not depend on the size of a sample. KL is essentially a comparison of histogram values. However, the choice of the binning strategy itself can impact the results. Like PSI, KL returns a score that can serve as the measure of the drift. A KL score can range from 0 to infinity. A score of 0 indicates that the distributions are identical. The higher the score, the more different the distributions are. Unlike PSI, KL is not symmetric. In other words, values differ when reference and sample distributions are swapped. In practical terms, KL behavior is very much like PSI. In the case of a minor 0.5% data change, the test has low sensitivity for both small and large datasets.

JS can be applied to numerical and categorical features. JS is another way to calculate the difference between two probability distributions. JS is based on KL with two major differences. The JS is always finite and symmetric. The square root of the JS divergence is a metric often referred to as JS distance. JS distance returns a score between 0 and 1. “0” corresponds to identical distributions and “1” to completely different distributions. This distinction makes JS a viable dataset distance determination metric.

WD is applied exclusively for numerical (non-categorical) features. By default, WD shows the absolute value of data drift. Roughly speaking, WD measures how much effort it takes to turn one distribution into another. The intuition behind WD is palpable. If drift happens in one direction (e.g., all values increase), the absolute value of the WD metric often equals the difference of means. Even if the changes happen in both directions (some values increase, some values decrease), the WD metric will sum the values up to reflect the change. The normed WD metric shows the number of standard deviations, on average, each object of the current group should be moved to match the reference group. This normed WD metric is interpretable as a dataset distance determination metric. When setting the drift detection threshold, the standard deviation can be relied upon. The normed WD metric returns a value from 0 to infinity, making the degree of drift comparable between features.

The Bhattacharyya distance uses a Bhattacharyya coefficient, which represents a measure of the amount of overlap between two statistical samples or populations by quantifying the closeness of the samples. The Bhattacharyya distance does not obey the triangle inequality and, therefore, does not adhere to metric space. The Hellinger distance is similar to the Bhattacharyya distance, except that the Hellinger distance obeys the triangle inequality and, therefore, can be considered a traditional metric. The Fisher's Exact Test is used to determine whether there is a significant association between two categorical variables. The Fisher's Exact Test can be used as an alternative to the X² test. Vector norm is a function that returns a magnitude of vector and comes in several forms (e.g., L1, L2, inf, etc.).

Returning to the example of the data set distance model validator 118 described herein, both the K-S test and the X² goodness of fit test provide statistical measures of the similarity between the parameter value distributions of the validating data set 114 and the inference data set 116 for each shared parameter, as well as a p-value that provides a likelihood that a null hypothesis is accepted or rejected. The p-value can be noisy, depending on the underlying data, so, in implementations, the p-value is ignored. The test statistics, however, directly compare the two distributions and provide a consistent metric for measuring similarity. In implementations, the data set distance model validator 118 uses the test statistics to determine the distance between data distributions of the shared parameters of the validating data set 114 and data distributions of the shared parameters of the inference data set 116. In an implementation, the data set distance model validator 118 encodes or otherwise vectorizes the parameter value distributions and/or the values in the distributions and determines a distance between the vector representations of the distributions of parameter values of the validating data set 114 and the inference data set 116.

In implementations, the data set distance model validator 118 standardizes, normalizes, and/or applies relative weights to the parameter distances between distributions of the shared parameter values of the validating data set 114 and the inference data set 116.

In implementations, the parameter distances between the distributions are susceptible to fluctuation normalization issues, scale standardization issues, and/or metric relevancy issues. With regard to the fluctuation normalization issues, failing to normalize for acceptable fluctuation complicates differentiating between changes that occur within the normal operation of a system and those that truly represent drift. With regard to the scale standardization issues, since each of the parameters is based on different types of tests for comparing separate statistics, there is no guarantee that the values of the parameter distances will reside on the same relative scale. Merging parameter distances across non-standardized values may result in improper unification. For example, when large values dwarf smaller values, the relative importance of the smaller values is disregarded, potentially leading to erroneous results. With regard to the metric relevancy issue, failing to account for the relative relevancy of different parameters to the operation of the inferential model 104 attributes incorrect relevance to certain parameters relative to other parameters.

In an implementation, the data set distance model validator 118 normalizes and/or standardizes the parameter distances to assume a common range of values between the shared parameters. The use of a standardization and/or normalization function across parameter distances of different shared parameters accounts for fluctuation normalization issues and scale standardization issues. In an implementation, the data set distance model validator 118 normalizes and standardizes using a standardization function, Γ, which transforms all individual parameter distances into a numerical space with common upper and lower bounds. In an implementation, the data set distance model validator 118 uses a function that normalizes an input value m with fixed values for scale and offset, as illustrated in equation (2),

$$Γ ( m ) = \frac{m - ζ}{η} , \qquad ( 2 )$$

where scale and offset factors are represented by η and ζ, respectively.

In an implementation, the data set distance model validator 118 applies parameter-specific correlative weights to the normalized parameter distances of the corresponding shared parameters to account for the relative relevancy of different parameters to the operation of the inferential model 104. By applying parameter-specific correlative weights αᵢ to the corresponding parameter distances, the data set distance model validator 118 can meaningfully assemble a single aggregate distance that unifies and contextually represents the parameter distances for the shared parameters. In an implementation, the data set distance model validator 118 determines the aggregate distance, AD, on a detection window ω from L parameter distances as in equation (3),

$$AD ( ω ) = {\sum }_{i = 1}^{L} {α}_{i} \cdot {Γ}_{i} ( {\hat{ψ}}_{i} ( ω ) ) = {\sum }_{i = 1}^{L} \frac{{α}_{i}}{{η}_{i}} ( {\hat{ψ}}_{i} ( ω ) - {ζ}_{i} ) , \qquad ( 3 )$$

where \hat{ψ}ᵢ(ω) represents the ith parameter distance calculated on detection window ω, Γᵢ represents the standardization function, and αᵢ represents the parameter-specific correlative weight used for the i^{th} metric value. Calculating AD on a time-indexed detection window set Ω^{[a,b]} provides a robust aggregate distance measure capable of monitoring drift over the given time period from a to b, AD^{[a,b]}.

The data set distance model validator 118 can use any number of methods to determine appropriate values for η, ζ, and α; these strategies range from manual selection to fully automated functions. In an implementation, the data set distance model validator 118 can receive manually chosen values for each of the parameter-specific correlative weights, scales, and offsets for some or all of the parameters. The manually chosen values can be based on existing clinical heuristics. Alternatively or additionally, the data set distance model validator 118 can use automatic methods to calculate values for η, ζ, and α for some or all of the parameters.

An example of operations by which the data set distance model validator 118 includes, first, calculating values for ηᵢ and ζᵢ using a detection window set collected from the validation data. Specifically, the data set distance model validator generates raw parameter distance values using individual parameter distance functions, ψᵢ on all windows in a detection window set. Then, the data set distance model validator 118 calculates the means and standard deviations of each parameter distance across the detection window set. Then, the data set distance model validator 118 sets each ζᵢ and ηᵢ to their corresponding mean and standard deviation. The data set distance model validator then obtains values for each αᵢ using a strategy that ties concordance directly to performance by leveraging the correlation between individual parameter distances, ψᵢ and performance on validation data. Specifically, each parameter-specific correlative weight, αᵢ , is calculated using a detection window set Ω_{α} as illustrated in equation (4),

αᵢ=|corr(Ω_{α}), ρ(Ω_{α}))|, (4)

where \hat{ψ}ᵢ(Ω_{α}) and ρ(Ω_{α}) represent the standardized metrics and performance on some detection window set Ω_{α}. In an implementation, the selection of Ω_{α} includes adding poor performance samples into Ωᵣ through hard data-mining of a validation set. In an implementation, the use of the detection window set Ωᵣ used to standardize metrics is often not suitable as it contains only high-performing samples (by design). The addition of poor performance samples into Ωᵣ through hard data-mining of the validation set can correct for this ideality.

The data set distance model validator 118 can monitor the aggregate distance (e.g., as determined using equations (3)-(4)) over time to determine whether the aggregate distance satisfies a validation condition. The satisfaction of the validation condition validates the inferential model 104 for operation on the inference data set 116. In various implementations, the satisfaction of the validation condition is based on the data set distance model validator 118 determining that a distance (e.g., parameter distance, a normalized parameter distance, a weighted distance, or an aggregate distance) is within a predefined range of values, exceeds a minimum threshold, or falls below a minimum threshold. In implementations, the validation condition is based on a difference between a time-series representation of the distance and a time-series representation of an expected distance (e.g., determined based on data on which the inferential model 104 is validated to operate). In an implementation, the difference between the time-series representations includes a difference determined at a particular time. In another example, the difference between the time-series representations includes an aggregate difference over time (e.g., the area between the time-series curves on a time plot over a predefined period of time or a predetermined number of discrete samples).

If the data set distance model validator 118 determines that the validation condition is satisfied, the data set distance model validator 118 validates the inferential model 104 for operation on the inference data set 116. Unlike traditional validators, such as the supervised learning model validator 108, that train using traditional validation methods that require labeled data, the data set distance model validator 118 can be deployed in real-time without requiring labeled data for the validation. The data set distance model validator 118 validates based on distances between the validating data set 114 and the inference data set 116.

In an implementation, the data set distance model validator 118 provides a real-time responsive action if the data set distance model validator 118 validates the inferential model 104 for operation on the inference data set 116. For example, the data set distance model validator 118 is deployed in a real-time system or a system that is provided updated data batches over time and indicates if the model has drifted sufficiently from normal activity to be considered unusable for the types of data being monitored. If the data set distance model validator 118 maintains the validation of the inferential model 104, the data set distance model validator 118 either provides a notification that the system is operating correctly or determines to not provide a notification that the system is operating incorrectly. Notifications can include visual or audible notifications provided by a real-time monitoring system. Notifications can also include communications over a network regarding whether the inferential model 104 is or remains validated for operation on the inference data set. Any notification can include an instruction that the inferential model 104 should be retrained.

As used herein, implementations of machine learning or inferential models 104 include, without limitation, one or more of data mining algorithms, artificial intelligence algorithms, masked learning models, natural language processing models, neural networks, artificial neural networks, perceptrons, feed-forward networks, radial basis neural networks, deep feed-forward neural networks, recurrent neural networks, long/short term memory networks, gated recurrent neural networks, autoencoders, variational autoencoders, denoising autoencoders, sparse autoencoders, Bayesian networks, regression models, decision trees, Markov chains, Hopfield networks, Boltzmann machines, restricted Boltzmann machines, deep belief networks, deep convolutional networks, genetic algorithms, deconvolutional neural networks, deep convolutional inverse graphics networks, generative adversarial networks, liquid state machines, extreme learning machines, echo state networks, deep residual networks, Kohonen networks, support vector machines, federated learning models, and neural Turing machines. In implementations, a model trainer trains and validates the machine learning models or inferential models 104 by an inference model training method. As used herein, implementations of training methods for training the machine learning or inferential models 104 (e.g., inferential and/or machine learning methods) include, without limitation, one or more of masked learning modeling, unsupervised learning, supervised learning, reinforcement learning, self-learning, feature learning, sparse dictionary learning, anomaly detection, robot learning, association rule learning, manifold learning, dimensionality reduction, bidirectional transformation, unidirectional transformation, gradient descent, autoregression, autoencoding, variational autoencoding, permutation language modeling, two-stream self attenuation, federated learning, absorbing transformer-XL, natural language processing (NLP), bidirectional encoder representations from transformers (BERT) models, and variants thereof

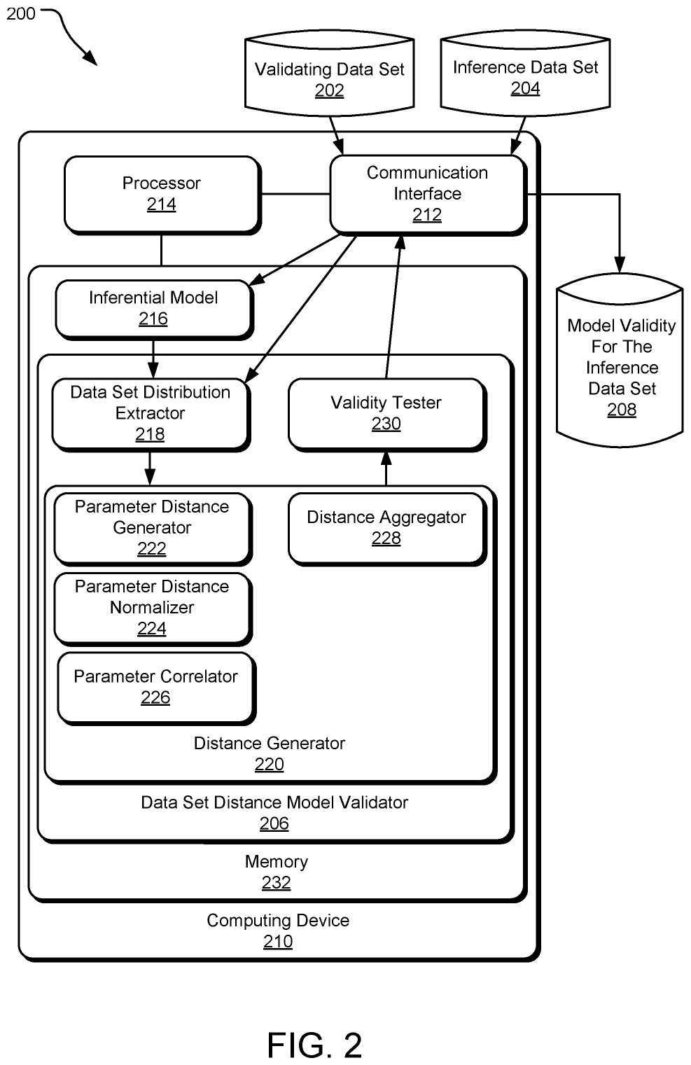

FIG. 2 illustrates an example data distance inferential model validation system 200. A validating data set 202 and an inference data set 204 are inputted into a communication interface 212 in a computing device that includes a processor 214 and memory 232. The memory 232 stores an inferential model 216 and a data set distance model validator 206. The inferential model 216 has been previously validated for operation on the validating data set 202 and has not been previously validated for operation on the inference data set 204.

In an implementation in which the data distance inferential model validation system 200 validates the inferential model 216 using input data configured to be input into the inferential model 216 from each of the validating data set 202 and the inference data set 204, the inputted validating data set 202 and inference data set 204 are transmitted to a data set distribution extractor 218 of the data set distance model validator 206. In implementations in which the data distance inferential model validation system 200 validates the inferential model 216 using output data output from the inferential model 216 in response to input of the input data into the inferential model 216, input data from the validating data set 202 and/or the inference data set 204 is input into the inferential model 216 to yield the output data (e.g., if either the validating data set 202 or the inference data set 204 do not include previously determined output data from the operation of the inferential model 216 before the input via the communication interface 212). In these implementations, the output data output by the inferential model 216 (if any) is additionally or alternatively transmitted to the data set distribution extractor 218.

The data set distribution extractor 218 extracts distributions from values of shared parameters. The shared parameters are parameters for which both the validating data set 202 and the inference data set 204 include values. The parameters represent different types of data. Input parameters represent input data configured to be input into the inferential model 216, and output parameters represent output data output by the inferential model 216 in response to input of the input data. In implementations, the input data includes sensor data and/or metadata.

The sensor data is time series or discrete data detected by a sensor. The sensor data can include one-dimensional (e.g., a simple data point for each time or discrete sampling point), two-dimensional (e.g., an image), or three-dimensional (e.g., a depth image or a three-dimensional composite of two-dimensional images). Examples of one-dimensional sensor data include measurements of temperature, blood analyte levels, other chemical level detections, physical displacements (e.g., of a person, animal, or object), and the like.

In implementations, the sensor data can include image data, such as static image data (e.g., an x-ray of a patient) or dynamic imaging data (video data). In implementations, rather than accepting raw image data, the inferential model 216 is configured to operate on reduced representation image data. Reduced representation image data can be generated by vectorizing and/or encoding the image data. For example, prior to introduction to or as an element of the inferential model 216, images are reduced in size of representation using vectorizing or encoding methods (e.g., by variational autoencoding, other autoencoding, downsampling, or other vectorizing or compression methods).

The metadata is data that describes data to be input into the inferential model 216. In an implementation, the inferential model 216 is configured to receive some or all of the metadata as input for inferential determinations. In an implementation, the metadata describes sensor data to be input into the inferential model 216 and can be used by the data set distance model validator 206 to validate the inferential model 216 (e.g., even if the inferential model 216 is not configured to receive the metadata as input).

The data set distribution extractor 218 extracts distributions of values for each of the shared parameters for each of the validating data set 202 and the inference data set 204 from the validating data set 202 and the inference data set 204 (and from any determined output from the inferential model 216 if not originally included in the validating data set 202 and/or the inference data set 204).

In implementations, the data set distribution extractor 218 controls the sampling of the values of the shared parameters used in the distributions of the values of each shared parameter of the validating data set 202 and inference data set 204 to prepare the distributions for comparison. In an implementation, the data set distribution extractor 218 samples the shared parameter values for the validating data set 202 and the inference data set 204 using a rolling detection window technique, an over-sampling technique, and/or a detection window set technique.

In an implementation, to construct sample detection windows, the data set distribution extractor 218 extracts or otherwise generates the parameter value distributions using a sliding window technique. Sliding window sampling functions have parameters for window length (l) and stride (s). The window length determines the size of each window, and the stride denotes the spacing between neighboring samples. Temporal-based stride and window length values are used to collect all sensor data (e.g., from patient exams) within a time window, looking back from the indexed date. For example, if the window length is 30 days, then a sample for December 31^{st} would include all exams from December 1^{st} through December 31^{st}. In an implementation, the multiple parameter values, mᵢ from each detection window, ω values are calculated using parameter functions Ψᵢ(ω)=mᵢ. In an implementation, to construct sample detection windows, the data set distribution extractor 218 generates the parameter value distributions using an oversampling technique. In implementations, similarity metrics are sensitive to sample size; even when two samples are drawn from the same distribution, the samples may produce differing results simply due to sample size. An oversampling technique mitigates this issue by repeatedly calculating metrics on a fixed-size sample and calculating an average result. In an implementation, a bootstrap method that samples the detection window to draw K samples is used. Metrics are then calculated on this bootstrapped sample. The process is repeated N times, and the results are averaged to obtain a final value. More formally, computation of a given metric on a detection window is a function Θ(·) that uses the sample and another function, θ^{K} to collect K samples from a detection window ω to calculate metric, ψᵢ, which is done N times, and then the results are aggregated as illustrated by equation (1), where θ^{K} is a function that collects K samples from ω with replacement.

In an implementation, to construct sample detection windows, the data set distribution extractor 218 generates the parameter value distributions using a detection window set technique. A detection window set is a collection of detection windows in which each detection window is typically captured with a time index. If the detection window taken at time t is denoted as co t , then some detection window set taken from time a to time b is defined as Ω^{[a,b]}={ωₐ, ωₐ₊₁, . . . , ω_{b-1}, ω_{b}}. Metrics (parameter values) are then collected at each time step, resulting in a metric (parameter) value set at multiple time steps: \hat{ψ}ᵢ(ω^{t})=\hat{m}ᵢ^{t} is defined as an individual metric (parameter) calculated at time t from detection window ω^{t}. Then metric (parameter) values \hat{m}ᵢ^{[a,b]}={\hat{m}ᵢ^{a}, \hat{m}ᵢ^{a+1}, . . . , \hat{m}ᵢ^{b-1}, \hat{m}ᵢ^{b}} are captured as the collection of \hat{m}ᵢ^{t} from a first time a to a second time b. Consequently, \hat{m}ᵢ^{[a,b]} is used as an individual measure of drift over time.

After the data set distribution extractor 218 extracts and assembles the distributions of values of the shared parameters, a distance generator 220 of the data set distance model validator 206 compares the extracted distributions of the shared parameters to determine distances between the distributions of values of shared parameters. In an implementation, a parameter distance generator 222 of the distance generator 220 separately compares distributions of values of the validating data set 202 and the inference data set 204 for each shared parameter to determine parameter distances for each shared parameter.

In an implementation, the parameter distance generator 222 uses a Kolmogorov-Smirnoff test (K-S test) to determine distances between distributions of parameter values with continuous values (or values of continuous variables sampled discretely). The K-S test is a non-parametric test used to measure the distribution shift of continuous variables from a reference sample. As a non-parametric test, the K-S test compares samples without assuming a specific distribution of a variable, making the K-S test an efficient and effective way to distinguish the distribution change from one time to another. Other tests for determining the distance between the distributions of continuous parameter values are contemplated.

In an implementation, for categorical features, the parameter distance generator 222 uses a X² (chi-square) goodness of fit test to determine distances between distributions of parameter values. The X² goodness of fit test is used to compare observed frequencies in data and compares them to expected values. The X² goodness of fit test calculates if an input sample with observed frequencies is likely to be obtained from the frequencies observed in the reference set. Other tests for determining a distance between the distributions of categorical or discrete parameter values are contemplated.

Both the K-S test and the X² goodness of fit test provide statistical measures of the similarity between the parameter value distributions of the validating data set 202 and the inference data set 204 for each shared parameter, as well as a p-value that provides a likelihood that a null hypothesis is accepted or rejected. The p-value can be noisy, depending on the underlying data, so, in implementations, the p-value is ignored. The test statistics, however, directly compare the two distributions and provide a consistent metric for measuring similarity. In implementations, the parameter distance generator 222 uses the test statistics to determine the distance between data distributions of the shared parameters of the validating data set 202 and data distributions of the shared parameters of the inference data set 204. In an implementation, the parameter distance generator 222 encodes or otherwise vectorizes the parameter value distributions and/or the values in the distributions and determines a distance between the vector representations of the distributions of parameter values of the validating data set 202 and the inference data set 204.

In implementations, a parameter distance normalizer 224 of the distance generator 220 standardizes and/or normalizes the parameter distances between distributions of the shared parameter values of the validating data set 202 and the inference data set 204.

In implementations, the parameter distances between the distributions are susceptible to fluctuation normalization issues or scale standardization issues. With regard to the fluctuation normalization issues, failing to normalize for acceptable fluctuation complicates differentiating between changes that occur within normal operation and those that truly represent drift. With regard to the scale standardization issues, since each of the parameters is based on different types of tests for comparing separate statistics, there is no guarantee that the values of the parameter distances will reside on the same relative scale. Merging parameter distances across non-standardized values may result in improper unification to generate an aggregate distance. For example, when large values dwarf smaller values, the relative importance of the smaller values is disregarded, potentially leading to erroneous results.

In an implementation, the parameter distance normalizer 224 normalizes and/or standardizes the parameter distances to assume a common range of values between the shared parameters. The use of a standardization and/or normalization function across parameter distances of different shared parameters accounts for fluctuation normalization issues and scale standardization issues. In an implementation, the parameter distance normalizer 224 normalizes and standardizes using a standardization function, Γ, which transforms all individual parameter distances into a numerical space with common upper and lower bounds. In an implementation, the parameter distance normalizer 224 uses a function that normalizes an input value m with fixed values for scale and offset, as illustrated in equation (2), where scale and offset factors are represented by η and ζ, respectively.

In implementations, the parameter distances between the distributions are susceptible to metric relevancy issues. With regard to the metric relevancy issue, failing to account for the relative relevancy of different parameters to the operation of the inferential model 216 attributes incorrect relevance to certain parameters relative to other parameters.

In an implementation, a parameter correlator 226 of the distance generator 220 applies parameter-specific correlative weights to the normalized parameter distances of the corresponding shared parameters to account for the relative relevancy of different parameters to the operation of the inferential model 216. By applying parameter-specific correlative weights αᵢ to the corresponding parameter distances, the parameter correlator 226 can attribute a relative value to each of the shared parameters to the validity of the operation of the inferential model 216 on the inference data set 204.

A distance aggregator 228 of the distance generator 220 assembles a single aggregate distance that unifies and contextually represents the parameter distances for the shared parameters. In an implementation, the distance aggregator 228 and/or the parameter correlator 226 applies parameter-specific correlative weights to the normalized parameter distances and determines the aggregate distance, AD, on a detection window ω from L parameter distances as in equation (3), where \hat{ψ}ᵢ(ω^{t}) represents the i^{th} parameter distance calculated on detection window ω, Γᵢ represents the standardization function, and αᵢ represents the parameter-specific correlative weight used for the i^{th} parameter distance value of the i^{th} parameter (“i” is an index of the shared parameters). Calculating AD on a time-indexed detection window set Ω^{[a,b]} provides a robust aggregate distance measure capable of monitoring drift over the given time period from a to b, AD^{[a,b]}. In the illustrated implementation, equation (3) functions both as a parameter correlator 226 (e.g., by multiplying the quantity by the parameter-specific correlative weights) that applies the parameter-specific correlative weights to the normalized parameter distances and the distance aggregator 228 that determines the aggregate distance (the output of equation (3)).

The distance generator 220 (e.g., the parameter correlator 226 and/or the distance aggregator 228) can use any number of methods to determine appropriate values for η, ζ, and α; these strategies range from manual selection to fully automated functions. In an implementation, the distance aggregator 228 can receive manually chosen values for each of the parameter-specific correlative weights, scales, and offsets for some or all of the parameters. The manually chosen values can be based on existing clinical heuristics. Alternatively or additionally, the distance generator 220 can use automatic methods to calculate values for η, ζ, and α for some or all of the parameters.

An example of operations by which the distance generator 220 calculates values for η, ζ, and α values includes, first, calculating values for ηᵢ and ζᵢ using a detection window set collected from the validation data. Specifically, the data set distance model validator generates raw parameter distance values using individual parameter distance functions ψᵢ on all windows in a detection window set. Then, the distance generator 220 calculates the means and standard deviations of each parameter distance across the detection window set. Then, the distance generator 220 sets each ζᵢ and ηᵢ to its corresponding mean and standard deviation. The data set distance model validator then obtains values for each αᵢ using a strategy that ties concordance directly to model performance by leveraging the correlation between individual parameter distances, ψᵢ and performance on validation data. Specifically, each parameter-specific correlative weight, αᵢ, is calculated using a detection window set Ω_{α}as illustrated in equation (4), where \hat{ψ}ᵢ (Ω_{α}) and ρ(Ω_{α}) represent the standardized metrics and performance on some detection window set Ω_{α}. In an implementation, the selection of Ω_{α}includes adding poor performance samples into Ωᵣ through hard data mining of a validation set. In an implementation, the use of the detection window set, Ωᵣ that was used to standardize metrics is often unsuitable, as it contains only high-performing samples (by design). The addition of poor performance samples into Ωᵣ through hard data-mining of the validation set can correct for this ideality. In implementations, the distance generator 220 outputs the aggregate distance to a validity tester 230 of the data set distance model validator 206.

The validity tester 230 can monitor the aggregate distance (e.g., as determined using equations (3)-(4)) over time to determine whether the aggregate distance satisfies a validation condition. The validity tester 230 validates the inferential model 216 for operation on the inference data set 204 based on the satisfaction of the validation condition. In various implementations, the satisfaction of the validation condition is based on the validity tester determining that a distance (e.g., parameter distance, a normalized parameter distance, a weighted distance, or an aggregate distance) is within a predefined range of values, exceeds a minimum threshold, or falls below a minimum threshold. In implementations, the validation condition is based on a difference between a time-series representation of the distance and a time-series representation of an expected distance (e.g., determined based on data on which the Inferential model 216 is validated to operate). In an implementation, the difference between the time-series representations includes a difference determined at a particular time or a discrete sample sampled at a particular time. In another example, the difference between the time-series representations includes an aggregate difference over time or a set of discrete samples (e.g., the area between the time-series curves on a time plot over a predefined period of time or a predetermined number of discrete samples).

If the validity tester 230 determines that the validation condition is satisfied, the data set distance model validator 206 validates the inferential model 216 for operation on the inference data set 204. In the illustrated implementation, the data set distance model validator 206 outputs model validity for the inference data set 208, representing that the inferential model 216 has been validated, responsive to the validation. Unlike traditional validators that train using traditional validation methods that require labeled data, the data set distance model validator 206 can be deployed in real-time without requiring labeled data for the validation. The data set distance model validator 206 validates based on distances between the validating data set 202 and the inference data set 204. In the illustrated implementation, the model validity for the inference data set 208 is output from the data set distance model validator 206 and from the computing device 210 via the communication interface 212 (or a different communication interface).

In an implementation, the data set distance model validator 206 provides a real-time responsive action if the data set distance model validator 206 validates the inferential model 216 for operation on the inference data set 204. For example, the data set distance model validator 206 is deployed in a real-time system or a system that is provided updated data batches over time and indicates if the inferential model 216 output has drifted sufficiently from normal activity to be considered unusable for the types of data being monitored. If the data set distance model validator 206 maintains the validation of the inferential model 216, the data set distance model validator 206 either provides a notification that the system is operating correctly or determines not to provide a notification that the system is operating incorrectly. Notifications can include visual or audible notifications provided by a real-time monitoring system. Notifications can also include communications over a network regarding whether the inferential model 216 is or remains validated for operation on the inference data set 204. Any notification can include an instruction that the inferential model 216 should be retrained.

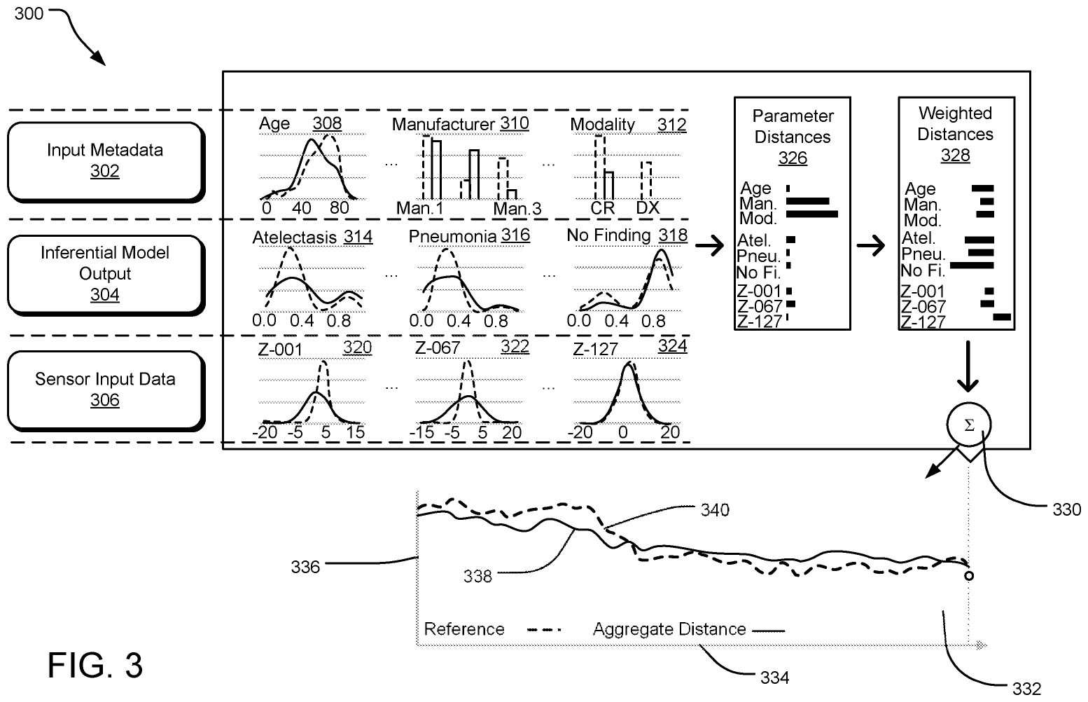

FIG. 3 illustrates an example of data throughput of a data distance inferential model validation system 300. The data distance inferential model validation system 300 is illustrated using a healthcare system, but implementations are contemplated in which the data distance inferential model validation system 300 applies to other fields that use inferential models. Data that a data set distance model validator uses to validate an inferential model includes input metadata 302, inferential model output 304, and/or sensor input data 306 of each of a validating data set and an inference data set. Examples of input metadata include values of input parameters, such as a patient's age, an equipment manufacturer's identity for equipment used in monitoring, and a modality. Examples of inferential model output include probabilities of an inferential finding, such as that a patient experiences atelectasis, that the patient experiences pneumonia, and/or that there is no finding of disease in the patient. Examples of sensor input include pixel data, time-series sensor data, and/or reduced representation sensor data (e.g., autoencoded or otherwise vectorized or compressed image representations).

A data set distribution extractor extracts the data values of each shared parameter and generates distributions of values of each of the shared parameters for each of the validating data set and the inference data set. In the illustrated implementation, age distributions for each of a validating data set (illustrated as a dashed line) and an inference data set (illustrated as a solid line) are illustrated in an age distribution plot 308. Analogous distributions of input metadata 302 parameters of manufacturer and modality are illustrated in a manufacturer distribution plot 310 and a modality plot 312, respectively. Example inferential model output 304 value distributions are similarly illustrated in an atelectasis distribution plot 314, a pneumonia distribution plot 316, and a no finding plot 318. Example sensor input data 306 value distributions are similarly illustrated. In the illustrated implementation, the sensor input data includes reduced representation data representing image data. In the illustrated implementation, the reduced representation is an autoencoded and/or vectorized version of the image data represented by values of different vector or autoencoder parameters. The illustrated Z-001 (first vector parameter values) distribution plot 320, Z-067 (67^{th} vector parameter values), distribution plot 322, and Z-127 (127^{th} vector values) distribution plot 324 illustrate distributions of each of the reduced representation autoencoder or vector values for each of the validating data set and the inference data set. While the illustrated plots may not be determined by the data distance inferential model validation system 300 at any point, the plots illustrate how the distributions of values of shared parameters differ between the validating data set and the inference data set.

The data set distance model validator includes a distance generator to determine a data set distance between the validating data set and the inference data set. A parameter distance generator of a distance generator generates parameter distances 326 between distributions of values for each shared parameter (e.g., using a testing method as disclosed herein). In an implementation, a parameter distance normalizer of the distance generator generates normalized parameter distances by normalizing and/or standardizing the parameter distances 326, as described herein. A parameter correlator of the distance generator applies parameter-specific correlative weights to the parameter distances 326 (e.g., normalized or standardized parameter distances) to generate weighted distances 328. A distance aggregator 330 (e.g., illustrated as a summer) of the distance generator generates an aggregate distance 338. In an implementation, the parameter correlator and the distance aggregator cooperate to generate the aggregate distance 338 in a single step (e.g., as illustrated in equation (3), in which parameter-specific correlative weights are applied and from which an aggregate distance is output).

In an implementation, the aggregate distance 338 is output as an aggregate distance signal, as illustrated. In the illustrated implementation, the aggregate distance 338 is presented as time series data on a time plot 332 in which an abscissa axis 334 represents time or a sample in a sequence of samples, and the ordinate axis 336 represents a magnitude of inferential model drift. A validity tester of the data set distance model validator evaluates the aggregate distance 338 to determine whether the aggregate distance 338 satisfies a validation condition. The time plot 332 further includes a reference signal representing an expected drift 340 of the inferential model output. The output of the inferential model will drift some, even if the inferential model is validated for operation on underlying data. The data set distance model validator can account for this by determining whether the aggregate distance 338 satisfies the validation condition.

The satisfaction of the validation condition validates the inferential model for operation on the inference data set. In various implementations, the satisfaction of the validation condition is based on the data set distance model validator determining that a distance (e.g., parameter distance, a normalized parameter distance, a weighted distance, or an aggregate distance) is within a predefined range of values, exceeds a minimum threshold, or falls below a minimum threshold. In implementations, the validation condition is based on a difference between a time-series representation of the aggregate distance 338 and a time-series representation of an expected drift 340 (e.g., determined based on data on which the inferential model is validated to operate). In an implementation, the difference between the time-series representations of the aggregate distance 338 and the expected drift 340 includes a difference determined at a particular time. In another example, the difference between the time-series representations of the aggregate distance 338 and the expected drift 340 includes an aggregate difference over time (e.g., the area between the time-series curves on a time plot over a predefined period of time or a predetermined number of discrete samples).

If the data set distance model validator determines that the validation condition is satisfied, the data set distance model validator validates the inferential model for operation on the inference data set. Unlike traditional validators that train using traditional validation methods that require labeled data, the data set distance model validator can be deployed in real-time without requiring labeled data for the validation. The data set distance model validator validates based on distances between the validating data set and the inference data set.

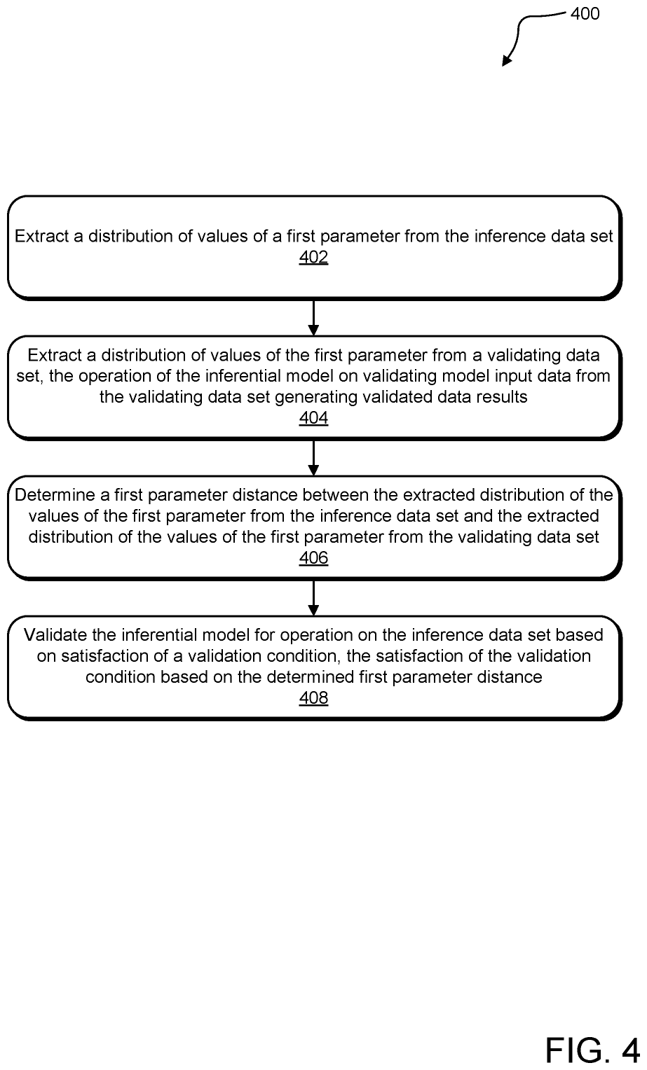

FIG. 4 illustrates example operations 400 for validating an inferential model for operation on an inference data set. An extracting operation 402 extracts a distribution of values of a first parameter from the inference data set. An extracting operation 404 extracts a distribution of values of the first parameter from a validating data set, the operation of the inferential model on validating model input data from the validating data set generating validated data results. In an implementation, the inference data set is collected under a first condition represented in the inference data set and the validating data set is collected under a second condition represented in the validating data set, and the first condition and the second condition at least partially differ and satisfaction of the validation condition is based on the first condition and the second condition.

In an implementation, the extracting operation 402 and the extracting operation 404 are conducted by a data set distribution extractor. In other implementations, the extracting operation 402 and the extracting operation 404 are conducted prior to the operations 400 (e.g., the extracted distributions are received) and can be omitted from the operations 400. The data set distribution extractor extracts distributions from values of shared parameters. The shared parameters are parameters for which both the validating data set and the inference data set include values. The parameters represent different types of data. Input parameters represent input data configured to be input into the inferential model, and output parameters represent output data output by the inferential model in response to input of the input data. In implementations, the input data includes sensor data and/or metadata.

The sensor data is time series or discrete data detected by a sensor. The sensor data can include one-dimensional (e.g., a simple data point for each time or discrete sampling point), two-dimensional (e.g., an image), or three-dimensional (e.g., a depth image or a three-dimensional composite of two-dimensional images). Examples of one-dimensional sensor data include measurements of temperature, blood analyte levels, other chemical level detections, physical displacements (e.g., of a person, animal, or object), and the like.

In implementations, the sensor data can include image data, such as static image data (e.g., an x-ray of a patient) or dynamic imaging data (video data). In implementations, rather than accepting raw image data, the inferential model is configured to operate on reduced representation image data. Reduced representation image data can be generated by vectorizing and/or encoding the image data. For example, prior to introduction to or as an element of the inferential model, images are reduced in size of representation using vectorizing or encoding methods (e.g., by variational autoencoding, other autoencoding, downsampling, or other vectorizing or compression methods).

The metadata is data that describes data to be input into the inferential model. In an implementation, the inferential model is configured to receive some or all of the metadata as input for inferential determinations. In an implementation, the metadata describes sensor data to be input into the inferential model and can be used by the data set distance model validator to validate the inferential model (e.g., even if the inferential model is not configured to receive the metadata as input).

The data set distribution extractor extracts distributions of values for each of the shared parameters for each of the validating data set and the inference data set from the validating data set and the inference data set (and from any determined output from the inferential model if not originally included in the validating data set and/or the inference data set).

In implementations, the data set distribution extractor controls the sampling of the values of the shared parameters used in the distributions of the values of each shared parameter of the validating data set and inference data set to prepare the distributions for comparison. In an implementation, the data set distribution extractor samples the shared parameter values for the validating data set and the inference data set using a rolling detection window technique, an over-sampling technique, and/or a detection window set technique.

In an implementation, to construct sample detection windows, the data set distribution extractor extracts or otherwise generates the parameter value distributions using a sliding window technique. Sliding window sampling functions have parameters for window length (l) and stride (s). The window length determines the size of each window, and the stride denotes the spacing between neighboring samples. Temporal-based stride and window length values are used to collect all sensor data (e.g., from patient exams) within a time window, looking back from the indexed date. For example, if the window length is 30 days, then a sample for December 31st would include all exams from December 1st through December 31st. In an implementation, the multiple parameter values, m i from each detection window, ω are calculated using parameter functions Ψᵢ(ω)=mᵢ.

In an implementation, to construct sample detection windows, the data set distribution extractor generates the parameter value distributions using an oversampling technique. In implementations, similarity metrics are sensitive to sample size; even when two samples are drawn from the same distribution, the samples may produce differing results simply due to sample size. An oversampling technique mitigates this issue by repeatedly calculating metrics on a fixed-size sample and calculating an average result. In an implementation, a bootstrap method that samples the detection window to draw K samples is used. Metrics are then calculated on this bootstrapped sample. The process is repeated N times, and the results are averaged to obtain a final value. More formally, computation of a given metric on a detection window is a function Θ(·) that uses the sample and another function, θ^{K} to collect K samples from a detection window ω to calculate the metric ψᵢ, which is done N times, and then the results are aggregated as illustrated by equation (1), where θ^{K} is a function that collects K samples from ω with replacement.

In an implementation, to construct sample detection windows, the data set distribution extractor generates the parameter value distributions using a detection window set technique. A detection window set is a collection of detection windows in which each detection window is typically captured with a time index. If the detection window taken at time t is denoted as co t , then some detection window set taken from time a to time b is defined as Ω^{[a,b]}={ωₐ, ωₐ₊₁, . . . , ω_{b-1}, ω_{b}}. Metrics (parameter values) are then collected at each time step, resulting in a metric (parameter) value set at multiple time steps: \hat{ψ}ᵢ(ω^{t})= \hat{m}ᵢ^{t} is defined as an individual metric (parameter) calculated at time t from the detection window ω^{t}. Then metric (parameter) values \hat{m}ᵢ^{[a,b]}={\hat{m}ᵢ^{a}, \hat{m}ᵢ^{a+1}, . . . , \hat{m}ᵢ^{b-1}, \hat{m}ᵢ^{b}} are captured as the collection of \hat{m}ᵢ^{t} from a first time, a to a second time, b. Consequently, \hat{m}ᵢ^{[a,b]} is used as an individual measure of drift over time.

Determining operation 406 determining a first parameter distance between the extracted distribution of the values of the first parameter from the inference data set and the extracted distribution of the values of the first parameter from the validating data set. In an implementation, the determining operation 406 uses a distance generator of the data set distance model validator to determine the first parameter distance. After the data set distribution extractor extracts and assembles the distributions of values of the shared parameters, the distance generator compares the extracted distributions of the shared parameters to determine distances between the distributions of values of shared parameters. In an implementation, a parameter distance generator of the distance generator separately compares distributions of values of the validating data set and the inference data set for each shared parameter to determine parameter distances for each shared parameter.

In an implementation, the parameter distance generator uses a Kolmogorov-Smirnoff test (K-S test) to determine distances between distributions of parameter values with continuous values (or values of continuous variables sampled discretely). The K-S test is a non-parametric test used to measure the distribution shift of continuous variables from a reference sample. As a non-parametric test, the K-S test compares samples without assuming a specific distribution of a variable, making the K-S test an efficient and effective way to distinguish the distribution change from one time to another. Other tests for determining the distances between the distributions of continuous parameter values are contemplated.

In an implementation, for categorical features, the parameter distance generator uses a X² (chi-square) goodness of fit test to determine distances between distributions of parameter values. The X² goodness of fit test is used to compare observed frequencies in data and compares them to expected values. The X² goodness of fit test calculates if an input sample with observed frequencies is likely to be obtained from the frequencies observed in the reference set. Other tests for determining a distance between the distributions of categorical or discrete parameter values are contemplated.

Both the K-S test and the X² goodness of fit test provide statistical measures of the similarity between the parameter value distributions of the validating data set and the inference data set for each shared parameter, as well as a p-value that provides a likelihood that a null hypothesis is accepted or rejected. The p-value can be noisy, depending on the underlying data, so, in implementations, the p-value is ignored. The test statistics, however, directly compare the two distributions and provide a consistent metric for measuring similarity. In implementations, the parameter distance generator uses the test statistics to determine the distance between data distributions of the shared parameters of the validating data set and data distributions of the shared parameters of the inference data set. In an implementation, the parameter distance generator encodes or otherwise vectorizes the parameter value distributions and/or the values in the distributions and determines a distance between the vector representations of the distributions of parameter values of the validating data set and the inference data set.

In implementations, the determining operation 406 includes a normalizing operation that normalizes the parameter distances. The normalizing operation uses a parameter distance normalizer of the distance generator to standardize and/or normalize the parameter distances between distributions of the shared parameter values of the validating data set and the inference data set.

In implementations, the parameter distances between the distributions are susceptible to fluctuation normalization issues or scale standardization issues. With regard to the fluctuation normalization issues, failing to normalize for acceptable fluctuation complicates differentiating between changes that occur within the normal operation of the system and those that truly represent drift. With regard to the scale standardization issues, since each of the parameters is based on different types of tests for comparing separate statistics, there is no guarantee that the values of the parameter distances will reside on the same relative scale. Merging parameter distances across non-standardized values may result in improper unification to generate an aggregate distance. For example, when large values dwarf smaller values, the relative importance of the smaller values is disregarded, potentially leading to erroneous results.

In an implementation, the parameter distance normalizer normalizes and/or standardizes the parameter distances to assume a common range of values between the shared parameters. The use of a standardization and/or normalization function across parameter distances of different shared parameters accounts for fluctuation normalization issues and scale standardization issues. In an implementation, the parameter distance normalizer normalizes and standardizes using a standardization function, F, which transforms all individual parameter distances into a numerical space with common upper and lower bounds.

In an implementation, the parameter distance normalizer uses a function that normalizes an input value m with fixed values for scale and offset, as illustrated in equation (2), where scale and offset factors are represented by η and ζ, respectively.

In implementations, the parameter distances between the distributions are susceptible to metric relevancy issues. With regard to the metric relevancy issue, failing to account for the relative relevancy of different parameters to the operation of the inferential model attributes incorrect relevance to certain parameters relative to other parameters.

In an implementation, the determining operation 406 includes an applying operation that applies a relative weight to the normalized first parameter distance to generate a weighted first parameter distance, the relative weight based on a predetermined correlative value of the first parameter relative to a second parameter represented in the inference data set and the validating data set. In an implementation, the applying operation uses a parameter correlator of the distance generator to apply the parameter-specific correlative weights to the normalized parameter distances of the corresponding shared parameters to account for the relative relevancy of different parameters to the operation of the inferential model. By applying parameter-specific correlative weights αᵢ to the corresponding parameter distances, the parameter correlator can attribute a relative value to each of the shared parameters to the validity of the operation of the inferential model on the inference data set.

A distance aggregator of the distance generator assembles a single aggregate distance that unifies and contextually represents the parameter distances for the shared parameters. In an implementation, the distance aggregator and/or the parameter correlator applies parameter-specific correlative weights to the normalized parameter distances and determines the aggregate distance, AD, on a detection window co from L parameter distances as in equation (3), where \hat{ψ}ᵢ(ω^{t}) represents the i^{th} parameter distance calculated on detection window ω, Γᵢ represents the standardization function, and αᵢ represents the parameter-specific correlative weight used for the i^{th} parameter distance value of the i^{th} parameter (“i” is an index of the shared parameters). Calculating AD on a time-indexed detection window set Ω^{[a,b]} provides a robust aggregate distance measure capable of monitoring drift over the given time period from a to b, AD^{[a,b]}. In the illustrated implementation, equation (3) functions both as a parameter correlator (e.g., by multiplying the quantity by the parameter-specific correlative weights) that applies the parameter-specific correlative weights to the normalized parameter distances and the distance aggregator that determines the aggregate distance (the output of equation (3)).

The data set distance model validator distance generator (e.g., the parameter correlator and/or the distance aggregator) can use any number of methods to determine appropriate values for η, ζ, and α; these strategies range from manual selection to fully automated functions. In an implementation, the distance aggregator can receive manually chosen values for each of the parameter-specific correlative weights, scales, and offsets for some or all of the parameters. The manually chosen values can be based on existing clinical heuristics. Alternatively or additionally, the distance generator can use automatic methods to calculate values for η, ζ, and α for some or all of the parameters.

An example of operations by which the distance generator calculates values for η, ζ, and α values include, first, calculating values for ηᵢ and ζᵢ using a detection window set collected from the validation data. Specifically, the data set distance model validator generates raw parameter distance values using individual parameter distance functions ψᵢ on all windows in a detection window set. Then, the distance generator calculates the means and standard deviations of each parameter distance across the detection window set. Then, the distance generator sets each ζᵢ and ηᵢ to its corresponding mean and standard deviation. The data set distance model validator then obtains values for each αᵢ using a strategy that ties concordance directly to model performance by leveraging the correlation between individual parameter distances, ψᵢ and performance on validation data. Specifically, each parameter-specific correlative weight, αᵢ , is calculated using a detection window set Ω_{α} as illustrated in equation (4), where \hat{ψ}ᵢ(Ω_{α}) and ρ(Ω_{α}) represent the standardized metrics and performance on some detection window set Ω_{α}. In an implementation, the selection of Ω_{α} includes adding poor performance samples into Ωᵣ through hard data mining of a validation set. In an implementation, the use of the detection window set Ωᵣ that was used to standardize metrics is often unsuitable, as it contains only high-performing samples (by design). The addition of poor performance samples into Ωᵣ through hard data-mining of the validation set can correct for this ideality. In implementations, the distance generator outputs the aggregate distance to a validity tester of the data set model distance generator. Elements of the extracting operation 402, the extracting operation 404, and the determining operation 406 can be repeated for each shared parameter to assemble weighted parameter distances that can be assembled into a single aggregated distance.

A validating operation 408 validates the inferential model for operation on the inference data set based on satisfaction of a validation condition, the satisfaction of the validation condition based on the determined first parameter distance. In an implementation, the validating operation 408 uses a validity tester that monitors the aggregate distance (e.g., as determined using equations (3)-(4)) to determine whether the aggregate distance satisfies a validation condition. The validity tester validates the inferential model for operation on the inference data set based on the satisfaction of the validation condition. In various implementations, the satisfaction of the validation condition is based on the validity tester determining that a distance (e.g., parameter distance, a normalized parameter distance, a weighted distance, an aggregate distance, or a vector distance) is within a predefined range of values, exceeds a predefined threshold, or falls below a predefined threshold. In implementations, the validation condition is based on a difference between a time-series representation of the distance and a time-series representation of an expected distance (e.g., determined based on data on which the inferential model is validated to operate). In an implementation, the difference between the time-series representations includes a difference determined at a particular time or a discrete sample sampled at a particular time. In another example, the difference between the time-series representations includes an aggregate difference over time or a set of discrete samples (e.g., the area between the time-series curves on a time plot over a predefined period of time or a predetermined number of discrete samples).

If the validity tester determines that the validation condition is satisfied, the data set distance model validator validates the inferential model for operation on the inference data set. In the illustrated implementation, the data set distance model validator outputs model validity for the inference data set, representing that the inferential model has been validated, responsive to the validation. Unlike traditional validators that train using traditional validation methods that require labeled data, the data set distance model validator can be deployed in real-time without requiring labeled data for the validation. The data set distance model validator validates based on distances between the validating data set and the inference data set. In the illustrated implementation, the model validity for the inference data set is output from the data set distance model validator and from the computing device via the communication interface (or a different communication interface).

In an implementation, the data set distance model validator provides a real-time responsive action if the data set distance model validator validates the inferential model for operation on the inference data set. For example, the data set distance model validator is deployed in a real-time system or a system that is provided updated data batches over time and indicates if the inferential model output has drifted sufficiently from normal activity to be considered unusable for the types of data being monitored. If the data set distance model validator maintains the validation of the inferential model, the data set distance model validator either provides a notification that the system is operating correctly or determines not to provide a notification that the system is operating incorrectly. Notifications can include visual or audible notifications provided by a real-time monitoring system. Notifications can also include communications over a network regarding whether the inferential model is or remains validated for operation on the inference data set. Any notification can include an instruction that the inferential model should be retrained.

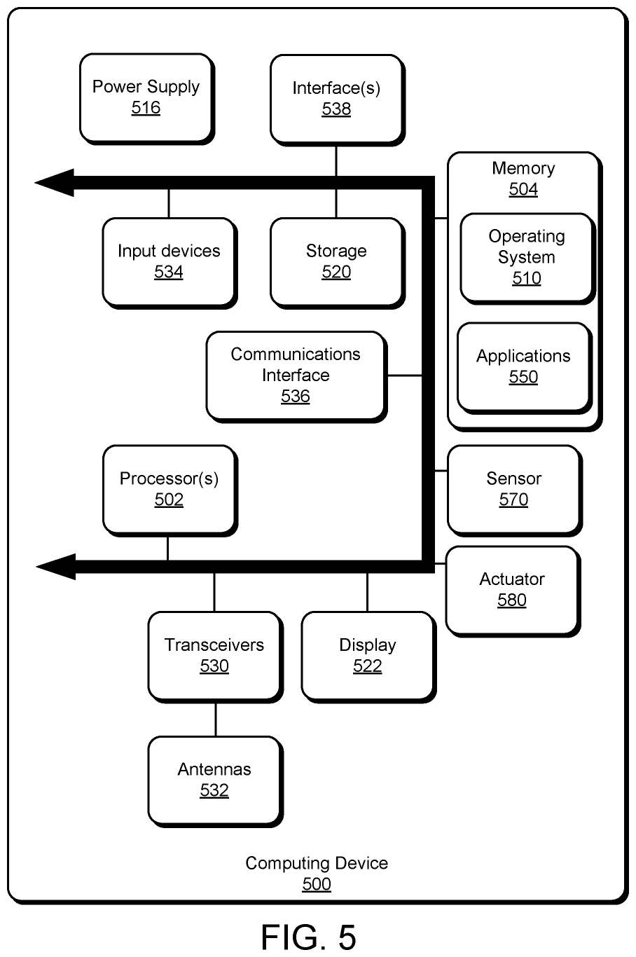

FIG. 5 illustrates an example computing device 500 for implementing the features and operations of the described technology. The computing device 500 may embody a remote-control device or a physical controlled device and is an example network-connected and/or network-capable device and may be a client device, such as a laptop, mobile device, desktop, tablet; a server/cloud device; an internet-of-things device; an electronic accessory; or another electronic device. The computing device 500 includes one or more processor(s) 502 (e.g., hardware processor(s)) and a memory 504. The memory 504 includes volatile memory (e.g., RAM) and/or nonvolatile memory (e.g., flash memory). The one or more processor(s) 502 are configured to execute instructions stored in the memory 504. For example, an operating system 510 resides in the memory 504 and is executed by the processor(s) 502.

In an example computing device 500, as shown in FIG. 5, one or more modules or segments, such as automated actuator protocols, applications 550, an inferential model, a data set distance model validator, a data set distribution extractor, a distance generator, an autoencoder, a vectorizer, a parameter distance generator, a parameter distance normalizer, a parameter correlator, a distance aggregator, and a validity tester are loaded into the operating system 510 on the memory 504 and/or storage 520 and executed by processor(s) 502. The storage 520 may include one or more tangible storage media devices and may store a predetermined threshold, a predetermined range, a parameter-specific correlative weight, a validating data set, an inference data set, share parameters, mode validity for an inference data set, input metadata, inferential model output, sensor input data, a parameter distance, a normalized parameter distance, a weighted distance, an aggregate distance, an expected model drift, a validation condition, an extracted distribution of values, a reduced representation parameter of raw sensor data, an expected distance, locally and globally unique identifiers, requests, responses, and other data and be local to the computing device 500 or may be remote and communicatively connected to the computing device 500.

The computing device 500 includes a power supply 516, which is powered by one or more batteries or other power sources and which provides power to other components of the computing device 500. The power supply 516 may also be connected to an external power source that overrides or recharges the built-in batteries or other power sources.

The computing device 500 may include one or more communication transceivers 530, which may be connected to one or more antenna(s) 532 to provide network connectivity (e.g., mobile phone network, Wi-Fi®, Bluetooth®) to one or more other servers and/or client devices (e.g., mobile devices, desktop computers, or laptop computers). The computing device 500 may further include a communications interface 536 (e.g., a network adapter), which is a type of computing device. The computing device 500 may use the communications interface 536 and any other types of computing devices for establishing connections over a wide-area network (WAN) or local-area network (LAN). It should be appreciated that the network connections shown are examples and that other computing devices and means for establishing a communications link between the computing device 500 and other devices may be used.

The computing device 500 may include one or more input devices 534 such that a user may enter commands and information (e.g., a keyboard or mouse). These and other input devices may be coupled to the server by one or more interfaces 538, such as a serial port interface, parallel port, or universal serial bus (USB). The computing device 500 may further include a display 522, such as a touchscreen display.

In implementations in which the computing device 500 includes or is an automated (e.g., robotic) device, the computing device 500 may include an actuator 580 adapted to engage elements of the apparatuses disclosed herein. The actuator 580 may be operable to perform operations disclosed herein (e.g., by executing by the processor(s) 502 automated actuator protocols stored in the storage 520 and/or the memory 504). The actuator 580 may be operated in conjunction with a sensor 570 to use detections of the sensor 570 to guide the motion of the actuator 580 in a feedback loop.

The computing device 500 may include a variety of tangible processor-readable storage media and intangible processor-readable communication signals. Tangible processor-readable storage can be embodied by any available media that can be accessed by the computing device 500 and includes both volatile and nonvolatile storage media, removable and non-removable storage media. The tangible processor-readable media are embodied with instructions for executing on the one or more processor(s) 502 and/or circuits of the computing device 500 a process. Tangible processor-readable storage media exclude communications signals (e.g., signals per se) and include volatile and nonvolatile, removable and non-removable storage media implemented in any method or technology for storage of information such as processor-readable instructions, data structures, program modules, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 500. In contrast to tangible processor-readable storage media, intangible processor-readable communication signals may embody processor-readable instructions, data structures, program modules, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program-specific and application-specific standard products (PSSP/ASSPs), system-on-a-chip (SOC), and complex programmable logic devices (CPLDs), for example.

The terms “module,” “program,” and “engine” may be used to describe an aspect of a remote-control device and/or a physically controlled device implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” and “engine” may encompass individual or groups of executable files, data files, libraries, drivers, scripts, database records, etc.

It will be appreciated that a “service,” as used herein, is an application program executable across one or multiple user sessions. A service may be available to one or more system components, programs, and/or other services. In some implementations, a service may run on one or more server computing devices.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language.

An example method of validating an inferential model for operation on an inference data set is provided. The method includes extracting a first distribution of values of a first parameter from the inference data set; extracting a second distribution of values of the first parameter from a validating data set used to validate the inferential model; determining a first parameter distance between the extracted first distribution and the extracted second distribution; and validating the inferential model for operation on the inference data set based on satisfaction of a validation condition, the satisfaction of the validation condition being based on the determined first parameter distance.

Another example method of any preceding method is provided, wherein the inference data set is collected under a first condition represented in the inference data set and the validating data set is collected under a second condition represented in the validating data set, the first condition and the second condition at least partially differ, and satisfaction of the validation condition is based on the first condition and the second condition.

Another example method of any preceding method is provided, the method further including normalizing the determined first parameter distance to generate a normalized first parameter distance, the normalized first parameter distance normalized to a predetermined range of values; and applying a relative weight to the normalized first parameter distance to generate a weighted first parameter distance, the relative weight based on a predetermined correlative value of the first parameter relative to a second parameter represented in the inference data set and the validating data set, wherein the satisfaction of the validation condition is based on the weighted first parameter distance.

Another example method of any preceding method is provided, the method further including extracting a third distribution of values of a second parameter from the inference data set; extracting a fourth distribution of values of the second parameter from the validating data set; determining a second parameter distance between the extracted third distribution and the extracted fourth distribution; and determining an aggregate distance based on the determined first parameter distance and the determined second parameter distance, wherein the satisfaction of the validation condition is based on the aggregate distance.

Another example method of any preceding method is provided, wherein the first parameter represents output from the inferential model, the extracted first distribution including a distribution of inference output parameter values output from the inferential model responsive to input of inference input data from the inference data set into the inferential model, the extracted second distribution including a distribution of validating output parameter values output from the inferential model responsive to input of validating model input data from the validating data set into the inferential model.

Another example method of any preceding method is provided, wherein the first parameter represents a metadata parameter, the extracted first distribution including a distribution of values of the metadata parameter from the inference data set, and the extracted second distribution including a distribution of values of the metadata parameter of the validating data set.

Another example method of any preceding method is provided, wherein the first parameter represents a sensor data parameter, the extracted first distribution including a distribution of values of the sensor data parameter from the inference data set, and the extracted second distribution including a distribution of values of the sensor data parameter of validating model input data of the validating data set configured to be input into the inferential model.

Another example method of any preceding method is provided, wherein the first parameter includes a reduced representation parameter of raw sensor data output by a sensor, the extracted first distribution including a distribution of values of the reduced representation parameter of raw sensor data of the inference data set, the extracted second distribution including a distribution of values of the reduced representation parameter of raw sensor data of validating model input data of the validating data set configured to be input into the inferential model.

An example system is provided. The system includes one or more hardware processors configured to execute instructions stored in memory and a data set distance model validator executable by the one or more hardware processors. The data set distance model validator includes a data set distribution extractor executable by the one or more hardware processors and configured to extract a first distribution of values of a first parameter from an inference data set and extract a second distribution of values of the first parameter from a validating data set used to validate an inferential model; a distance generator executable by the one or more hardware processors, the distance generator including a parameter distance generator executable by the one or more hardware processors and configured to determine a first parameter distance between the extracted first distribution and the extracted second distribution; and a validity tester executable by the one or more hardware processors and configured to validate the inferential model for operation on the inference data set based on satisfaction of a validation condition, the satisfaction of the validation condition being based on the determined first parameter distance.

Another example system of any preceding system is provided, wherein the inference data set is collected under a first condition represented in the inference data set, and the validating data is collected under a second condition represented in the validating data set, the first condition and the second condition at least partially differ, and satisfaction of the validation condition is based on the first condition and the second condition.

Another example system of any preceding system is provided, wherein the distance generator further includes a parameter distance normalizer executable by the one or more hardware processors and configured to normalize the determined first parameter distance to generate a normalized first parameter distance, the normalized first parameter distance normalized to a predetermined range of values and a parameter correlator executable by the one or more hardware processors and configured to apply a relative weight to the normalized first parameter distance to generate a weighted first parameter distance, the relative weight based on a predetermined correlative value of the first parameter relative to a second parameter represented in the inference data set and the validating data set, wherein the satisfaction of the validation condition is based on the weighted first parameter distance.

Another example system of any preceding system is provided, wherein the distance generator further includes a distance aggregator executable by the one or more hardware processors, wherein the data set distribution extractor is further configured to: extract a third distribution of values of a second parameter from the inference data set; and extract a fourth distribution of values of the second parameter from the validating data set, wherein operation of the inferential model on the validating data set generates validated data results, the distance generator is further configured to determine a second parameter distance between the extracted third distribution and the extracted fourth distribution, and the distance aggregator is configured to determine an aggregate distance based on the determined first parameter distance and the determined second parameter distance, wherein the satisfaction of the validation condition is based on the aggregate distance.

Another example system of any preceding system is provided, wherein the first parameter represents output from the inferential model, the extracted first distribution including a distribution of inference output parameter values output from the inferential model responsive to input of inference input data from the inference data set into the inferential model, the extracted second distribution including a distribution of validating output parameter values output from the inferential model responsive to input of validating model input data from the validating data set into the inferential model.

Another example system of any preceding system is provided, wherein the first parameter represents a metadata parameter, the extracted first distribution including a distribution of values of the metadata parameter from the inference data set, and the extracted second distribution including a distribution of values of the metadata parameter of the validating data set.

Another example system of any preceding system is provided, wherein the first parameter represents a sensor data parameter, the extracted first distribution including a distribution of values of the sensor data parameter from the inference data set, and the extracted second distribution including a distribution of values of the sensor data parameter of validating model input data of the validating data set configured to be input into the inferential model.

One or more example tangible processor-readable storage media embodied with instructions for executing on one or more processors and circuits of a computing device a process of validating an inferential model for operation on an inference data set is provided. The process includes extracting a first distribution of values of a first parameter from the inference data set; extracting a second distribution of values of the first parameter from a validating data set used to validate ; determining a first parameter distance between the extracted first distribution and the extracted second distribution; and validating the inferential model for operation on the inference data set based on satisfaction of a validation condition, the satisfaction of the validation condition being based on the determined first parameter distance.

One or more other example tangible processor-readable storage media of any preceding media are provided, wherein the inference data set represents data collected under first conditions represented in the inference data set, and the validating data set is collected under second conditions represented in validating model input data from the validating data set configured to be input into the inferential model, wherein the first conditions and second conditions at least partially differ.

One or more other example tangible processor-readable storage media of any preceding media are provided, the process further including normalizing the determined first parameter distance to generate a normalized first parameter distance, the normalized first parameter distance normalized to a predetermined range of values; and applying a relative weight to the normalized first parameter distance to generate a weighted first parameter distance, the relative weight based on a predetermined correlative value of the first parameter relative to a second parameter represented in the inference data set and the validating data set, wherein the satisfaction of the validation condition is based on the weighted first parameter distance.

One or more other example tangible processor-readable storage media of any preceding media are provided, the process further including extracting a third distribution of values of a second parameter from the inference data set; extracting a fourth distribution of values of the second parameter from the validating data set, wherein operation of the inferential model on the validating data set generates validated data results; determining a second parameter distance between the extracted third distribution and the extracted fourth distribution; and determining an aggregate distance based on the determined first parameter distance and the determined second parameter distance, wherein the satisfaction of the validation condition is based on the aggregate distance.

One or more other example tangible processor-readable storage media of any preceding media are provided, wherein the first parameter represents a sensor data parameter, the extracted first distribution including a distribution of values of the sensor data parameter from the inference data set, and the extracted second distribution including a distribution of values of the sensor data parameter of the validating data set.

An example system of validating an inferential model for operation on an inference data set is provided. The system includes means for extracting a first distribution of values of a first parameter from the inference data set; means for extracting a second distribution of values of the first parameter from a validating data set used to validate the inferential model; means for determining a first parameter distance between the extracted first distribution and the extracted second distribution; and means for validating the inferential model for operation on the inference data set based on satisfaction of a validation condition, the satisfaction of the validation condition being based on the determined first parameter distance.

Another example system of any preceding system is provided, wherein the inference data set is collected under a first condition represented in the inference data set and the validating data set is collected under a second condition represented in the validating data set, the first condition and the second condition at least partially differ, and satisfaction of the validation condition is based on the first condition and the second condition.

Another example system of any preceding system is provided, the system further including means for normalizing the determined first parameter distance to generate a normalized first parameter distance, the normalized first parameter distance normalized to a predetermined range of values and the system further including means for applying a relative weight to the normalized first parameter distance to generate a weighted first parameter distance, the relative weight based on a predetermined correlative value of the first parameter relative to a second parameter represented in the inference data set and the validating data set, wherein the satisfaction of the validation condition is based on the weighted first parameter distance.

Another example system of any preceding system is provided, the system further including means for extracting a third distribution of values of a second parameter from the inference data set; means for extracting a fourth distribution of values of the second parameter from the validating data set; means for determining a second parameter distance between the extracted third distribution and the extracted fourth distribution; and means for determining an aggregate distance based on the determined first parameter distance and the determined second parameter distance, wherein the satisfaction of the validation condition is based on the aggregate distance.

Another example system of any preceding system is provided, wherein the first parameter represents output from the inferential model, the extracted first distribution including a distribution of inference output parameter values output from the inferential model responsive to input of inference input data from the inference data set into the inferential model, the extracted second distribution including a distribution of validating output parameter values output from the inferential model responsive to input of validating model input data from the validating data set into the inferential model.

Another example system of any preceding system is provided, wherein the first parameter represents a metadata parameter, the extracted first distribution including a distribution of values of the metadata parameter from the inference data set, and the extracted second distribution including a distribution of values of the metadata parameter of the validating data set.

Another example system of any preceding system is provided, wherein the first parameter represents a sensor data parameter, the extracted first distribution including a distribution of values of the sensor data parameter from the inference data set, and the extracted second distribution including a distribution of values of the sensor data parameter of validating model input data of the validating data set configured to be input into the inferential model.

Another example system of any preceding system is provided, wherein the first parameter includes a reduced representation parameter of raw sensor data output by a sensor, the extracted first distribution including a distribution of values of the reduced representation parameter of raw sensor data of the inference data set, the extracted second distribution including a distribution of values of the reduced representation parameter of raw sensor data of validating model input data of the validating data set configured to be input into the inferential model.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can, in some cases, be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Thus, particular implementations of the subject matter have been described. Other implementations are within the scope of the following claims. Nevertheless, it will be understood that various modifications can be made without departing from the spirit and scope of the recited claims.

As used herein, terms such as “substantially,” “about,” “approximately,” or other terms of relative degree are interpreted as a person skilled in the art would interpret the terms and/or amount to a magnitude of variability of one or more of 1%, 2%, 3%, 4%, 5%, 6%, 7%, 8%, 9%, 10%, 11%, 12%, 13%, 14%, or 15% of a metric relative to the quantitative or qualitative feature described. For example, a term of relative degree applied to orthogonality suggests an angle may have a magnitude of variability relative to a right angle. When values are presented herein for particular features and/or a magnitude of variability, ranges above, ranges below, and ranges between the values are contemplated.

What is claimed is:

1. A method of validating an inferential model for operation on an inference data set, the method comprising:
extracting a first distribution of values of a first parameter from the inference data set;
extracting a second distribution of values of the first parameter from a validating data set used to validate the inferential model;
determining a first parameter distance between the extracted first distribution and the extracted second distribution; and
validating the inferential model for operation on the inference data set based on satisfaction of a validation condition, the satisfaction of the validation condition being based on the determined first parameter distance.

2. The method of claim 1, wherein the inference data set is collected under a first condition represented in the inference data set and the validating data set is collected under a second condition represented in the validating data set, the first condition and the second condition at least partially differ, and satisfaction of the validation condition is based on the first condition and the second condition.

3. The method of claim 1, further comprising:
normalizing the determined first parameter distance to generate a normalized first parameter distance, the normalized first parameter distance normalized to a predetermined range of values; and
applying a relative weight to the normalized first parameter distance to generate a weighted first parameter distance, the relative weight based on a predetermined correlative value of the first parameter relative to a second parameter represented in the inference data set and the validating data set, wherein the satisfaction of the validation condition is based on the weighted first parameter distance.

4. The method of claim 1, further comprising:
extracting a third distribution of values of a second parameter from the inference data set;
extracting a fourth distribution of values of the second parameter from the validating data set;
determining a second parameter distance between the extracted third distribution and the extracted fourth distribution; and
determining an aggregate distance based on the determined first parameter distance and the determined second parameter distance, wherein the satisfaction of the validation condition is based on the aggregate distance.

5. The method of claim 1, wherein the first parameter represents output from the inferential model, the extracted first distribution including a distribution of inference output parameter values output from the inferential model responsive to input of inference input data from the inference data set into the inferential model, the extracted second distribution including a distribution of validating output parameter values output from the inferential model responsive to input of validating model input data from the validating data set into the inferential model.

6. The method of claim 1, wherein the first parameter represents a metadata parameter, the extracted first distribution including a distribution of values of the metadata parameter from the inference data set, and the extracted second distribution including a distribution of values of the metadata parameter of the validating data set.

7. The method of claim 1, wherein the first parameter represents a sensor data parameter, the extracted first distribution including a distribution of values of the sensor data parameter from the inference data set, and the extracted second distribution including a distribution of values of the sensor data parameter of validating model input data of the validating data set configured to be input into the inferential model.

8. The method of claim 1, wherein the first parameter includes a reduced representation parameter of raw sensor data output by a sensor, the extracted first distribution including a distribution of values of the reduced representation parameter of raw sensor data of the inference data set, the extracted second distribution including a distribution of values of the reduced representation parameter of raw sensor data of validating model input data of the validating data set configured to be input into the inferential model.

9. A system, comprising:
one or more hardware processors configured to execute instructions stored in memory; and
a data set distance model validator executable by the one or more hardware processors, the data set distance model validator including:
a data set distribution extractor executable by the one or more hardware processors and configured to extract a first distribution of values of a first parameter from an inference data set and extract a second distribution of values of the first parameter from a validating data set used to validate an inferential model;
a distance generator executable by the one or more hardware processors, the distance generator including a parameter distance generator executable by the one or more hardware processors and configured to determine a first parameter distance between the extracted first distribution and the extracted second distribution; and
a validity tester executable by the one or more hardware processors and configured to validate the inferential model for operation on the inference data set based on satisfaction of a validation condition, the satisfaction of the validation condition being based on the determined first parameter distance.

10. The system of claim 9, wherein the inference data set is collected under a first condition represented in the inference data set, and the validating data is collected under a second condition represented in the validating data set, the first condition and the second condition at least partially differ, and satisfaction of the validation condition is based on the first condition and the second condition.

11. The system of claim 9, the distance generator further comprising:
a parameter distance normalizer executable by the one or more hardware processors and configured to normalize the determined first parameter distance to generate a normalized first parameter distance, the normalized first parameter distance normalized to a predetermined range of values; and
a parameter correlator executable by the one or more hardware processors and configured to apply a relative weight to the normalized first parameter distance to generate a weighted first parameter distance, the relative weight based on a predetermined correlative value of the first parameter relative to a second parameter represented in the inference data set and the validating data set, wherein the satisfaction of the validation condition is based on the weighted first parameter distance.

12. The system of claim 9, the distance generator further comprising:
a distance aggregator executable by the one or more hardware processors,
wherein the data set distribution extractor is further configured to:
extract a third distribution of values of a second parameter from the inference data set; and
extract a fourth distribution of values of the second parameter from the validating data set, wherein operation of the inferential model on the validating data set generates validated data results, the distance generator is further configured to determine a second parameter distance between the extracted third distribution and the extracted fourth distribution, and the distance aggregator is configured to determine an aggregate distance based on the determined first parameter distance and the determined second parameter distance, wherein the satisfaction of the validation condition is based on the aggregate distance.

13. The system of claim 9, wherein the first parameter represents output from the inferential model, the extracted first distribution including a distribution of inference output parameter values output from the inferential model responsive to input of inference input data from the inference data set into the inferential model, the extracted second distribution including a distribution of validating output parameter values output from the inferential model responsive to input of validating model input data from the validating data set into the inferential model.

14. The system of claim 9, wherein the first parameter represents a metadata parameter, the extracted first distribution including a distribution of values of the metadata parameter from the inference data set, and the extracted second distribution including a distribution of values of the metadata parameter of the validating data set.

15. The system of claim 9, wherein the first parameter represents a sensor data parameter, the extracted first distribution including a distribution of values of the sensor data parameter from the inference data set, and the extracted second distribution including a distribution of values of the sensor data parameter of validating model input data of the validating data set configured to be input into the inferential model.

16. One or more tangible processor-readable storage media embodied with instructions for executing on one or more processors and circuits of a computing device a process of validating an inferential model for operation on an inference data set, the process comprising:
extracting a first distribution of values of a first parameter from the inference data set;
extracting a second distribution of values of the first parameter from a validating data set used to validate;
determining a first parameter distance between the extracted first distribution and the extracted second distribution; and
validating the inferential model for operation on the inference data set based on satisfaction of a validation condition, the satisfaction of the validation condition being based on the determined first parameter distance.

17. The one or more tangible processor-readable storage media of claim 16, wherein the inference data set represents data collected under first conditions represented in the inference data set, and the validating data set is collected under second conditions represented in validating model input data from the validating data set configured to be input into the inferential model, wherein the first conditions and second conditions at least partially differ.

18. The one or more tangible processor-readable storage media of claim 16, the process further comprising:
normalizing the determined first parameter distance to generate a normalized first parameter distance, the normalized first parameter distance normalized to a predetermined range of values; and
applying a relative weight to the normalized first parameter distance to generate a weighted first parameter distance, the relative weight based on a predetermined correlative value of the first parameter relative to a second parameter represented in the inference data set and the validating data set,
wherein the satisfaction of the validation condition is based on the weighted first parameter distance.

19. The one or more tangible processor-readable storage media of claim 16, the process further comprising:
extracting a third distribution of values of a second parameter from the inference data set;
extracting a fourth distribution of values of the second parameter from the validating data set, wherein operation of the inferential model on the validating data set generates validated data results;
determining a second parameter distance between the extracted third distribution and the extracted fourth distribution; and
determining an aggregate distance based on the determined first parameter distance and the determined second parameter distance, wherein the satisfaction of the validation condition is based on the aggregate distance.

20. The one or more tangible processor-readable storage media of claim 16, wherein the first parameter represents a sensor data parameter, the extracted first distribution including a distribution of values of the sensor data parameter from the inference data set, and the extracted second distribution including a distribution of values of the sensor data parameter of the validating data set.
